(19) United States
(12) Patent Application Publication
(10) Pub. No.: US 2019/0205069 A1
(43) Pub. Date: Jul. 4, 2019

(54) DATA PROCESSING APPARATUS AND NON-TRANSITORY COMPUTER-READABLE STORAGE MEDIUM FOR STORING PROGRAM

(71) Applicant: FUJITSU LIMITED, Kawasaki-shi (JP)

(72) Inventors: JUNKI HAKAMATA, Yokohama (JP); TSUYOSHI TANEISHI, Shizuoka (JP); Ryosuke Hyogo, Yokohama (JP)

(73) Assignee: FUJITSU LIMITED, Kawasaki-shi (JP)

(21) Appl. No.: 16/221,531

(22) Filed: Dec. 16, 2018

(30) Foreign Application Priority Data
Dec. 28, 2017 (JP) 2017-254542

(51) Int. Cl. G06F 3/12; H04N 1/00

(52) U.S. Cl. CPC G06F 3/126; G06F 3/1205; H04N 2201/0094; G06F 3/1288; H04N 1/00954; G06F 3/1268

(57) ABSTRACT

A data processing apparatus is configured to: receive first information associated with an image forming apparatus; issue, to a server apparatus that manages first data, a first request being a request for a first data set including at least any one of the first data to be transferred to the image forming apparatus and the first data corresponding to second data to be transmitted to the image forming apparatus; receive the first data set requested by the first request; and issue a second request being a request for a second data set, the second data set including at least any one of the first data to be transferred to the image forming apparatus and the first data corresponding to the second data to be transmitted to the image forming apparatus, and a content of the second data set being different from a content of the first data set.

### CROSS-REFERENCE TO RELATED APPLICATION

This application is based upon and claims the benefit of priority of the prior Japanese Patent Application No. 2017-254542, filed on Dec. 28, 2017, the entire contents of which are incorporated herein by reference.

### FIELD

The embodiments discussed herein are related to a data processing apparatus and a non-transitory computer-readable storage medium for storing a program.

### BACKGROUND

A load balancing technology has been known that distributes a request from a client to processing servers that are multiplexed. In processing on print jobs, the order of processing is also known to have a significance, for example, it is desirable that print jobs for the same printer be processed in order of requests. In applications in which the order of processing on print jobs or the like has a significance, it is also known to be difficult for the aforementioned technology to ensure the order of processing before the processing is distributed to the processing servers.

Examples of the related art include Japanese Laid-open Patent Publication No. 2013-105237.

### SUMMARY

According to an aspect of the embodiments, a data processing apparatus includes: a memory; and a processor coupled to the memory and configured to execute a process that includes receiving first information associated with an image forming apparatus, issuing, to a server apparatus that manages first data, a first request after receiving the first information, the first request being a request for a first data set, the first data set including at least any one of the first data to be transferred to the image forming apparatus and the first data corresponding to second data to be transmitted to the image forming apparatus, receiving the first data set requested by the first request, and issuing, to the server apparatus, a second request after receiving the first data set, the second request being a request for a second data set, the second data set including at least any one of the first data to be transferred to the image forming apparatus and the first data corresponding to the second data to be transmitted to the image forming apparatus, and a content of the second data set being different from a content of the first data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a printing assisting system;

FIG. 2 illustrates an example of the hardware configuration of a server apparatus;

FIG. 3 is a diagram illustrating details of a data center according to a first embodiment;

FIG. 4A is an example of a block diagram of one web server;

FIG. 4B is an example of a block diagram of one management server;

FIG. 5A is an example of a block diagram of a storage server;

FIG. 5B is an example of a block diagram of a database server;

FIG. 6 is an example of a job-information storage unit;

FIG. 7 is an example of a block diagram of one print server;

FIG. 8 is a processing sequence diagram illustrating an example of storage processing;

FIG. 9 is a processing sequence diagram illustrating an example of display processing;

FIG. 10 illustrates an example of a print-target selection screen;

FIG. 11 is a processing sequence diagram (part 1) illustrating an example of print processing according to the first embodiment;

FIG. 12 is a processing sequence diagram (part 2) illustrating the example of the print processing according to the first embodiment;

FIGS. 13A to 13C illustrate an example of a first management table;

FIGS. 14A to 14C illustrate an example of a second management table;

FIG. 15 is a diagram illustrating details of a data center according to a second embodiment;

FIG. 16 is an example of a block diagram of a monitoring server;

FIG. 17 is a processing sequence diagram illustrating an example of print processing according to the second embodiment; and

FIGS. 18A and 18B illustrate another example of the second management table.

### DESCRIPTION OF EMBODIMENTS

For example, when two consecutive print jobs are distributed to processing servers having equivalent capabilities, based on the above-described technology, the order that processing for the two print jobs is completed may vary from the order of the distributions, depending on the amount of processing (for example, the amount of data or the amount of pages) involved for processing the two print jobs.

When the print jobs on which the processing has been completed are output from the processing servers to the same printer, the print job on which the processing was completed earlier is executed by the printer, and then the print job on which the processing has been completed later is executed by the printer. For example, there are cases in which prints are output from the printer in a printing order that differs from the order that the print jobs were requested, and there is a problem in that variations occur in the printing order.

Accordingly, one aspect is intended to provide a data processing program, a data processing method, and a data processing apparatus with which variations in the printing order do not occur.

Embodiments for implementing the present disclosure will be described below with reference to the accompanying drawings.

### First Embodiment

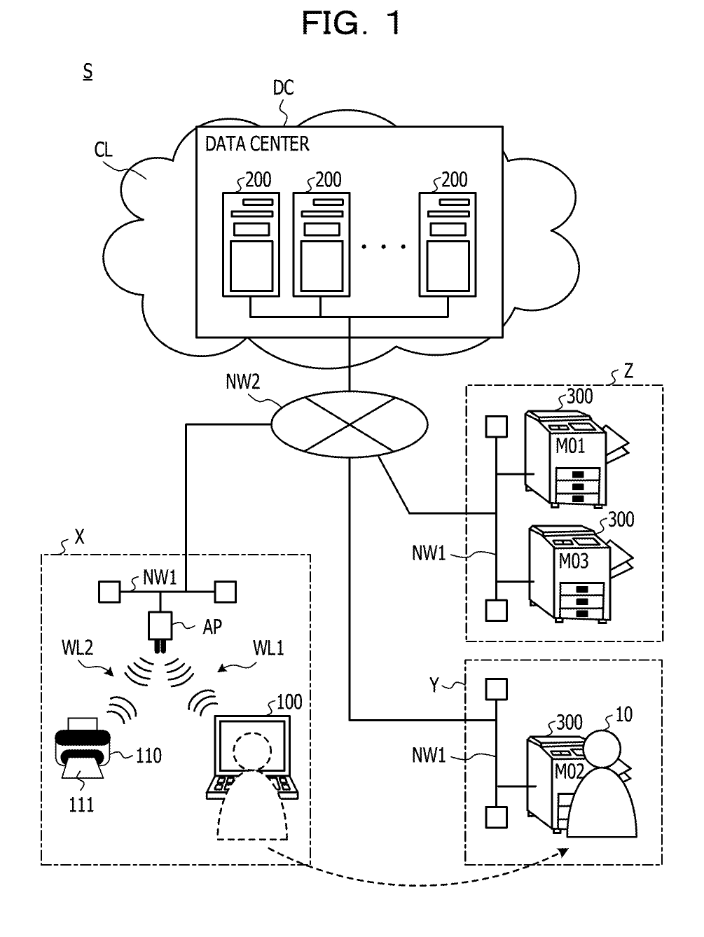

FIG. 1 is a diagram illustrating an example of a printing assisting system S. The printing assisting system S includes a client terminal 100, a plurality of server apparatuses 200, and a plurality of pieces of multifunctional equipment 300. Each piece of multifunctional equipment 300 is office equipment having at least a printing function and a communication function. Each piece of multifunctional equipment 300 may have at least one of a facsimile function and a scanner function. Although, in FIG. 1, the plurality of pieces of multifunctional equipment 300 is illustrated as an example of image forming apparatuses, at least one of the manufacturer and the model of each piece of multifunctional equipment 300 differs from those of the other multifunctional equipment 300. Although details are described below, some or all of the pieces of multifunctional equipment 300 may be printers. The server apparatuses 200 are placed at a data center DC in a cloud CL. The server apparatuses 200 may also be placed in-house without being placed at the data center DC. For example, the printing assisting system S may be operated as a cloud system or an on-premise system. Details of functions of the plurality of server apparatuses 200, which are illustrated in FIG. 1, are described later.

The client terminal 100 is operated by a user 10 who uses the printing assisting system S. The client terminal 100 is operated, for example, at site X. Examples of site X include a home of the user 10 and a facility, such as a business facility or a factory, owned by an entity. The client terminal 100 generates various document files, based on an operation performed by the user 10. The client terminal 100 generates and outputs a print job, based on an operation performed by the user 10. The print job is a data for causing a printer 110, placed at site X, or the multifunctional equipment 300 to print a document file.

For example, when the user 10 performs an operation for causing the printer 110 to print a document file, the client terminal 100 generates a print job in a rendering format, which is dependent on the model and the manufacturer of the printer 110, based on the operation, and transmits the generated print job in the rendering format to the printer 110. One example of the print job in the rendering format is a print job in a Page Description Language (PDL) format. A print job in a rendering format will hereinafter be referred to as a “rendering job”.

The client terminal 100 and the printer 110 are connected to each other via an access point AP connected to a communications network NW1. The rendering job transmitted from the client terminal 100 arrives at the access point AP through a wireless communication WL1, and the access point AP transfers the rendering job to the printer 110 through a wireless communication WL2. Based on an analysis result of the rendering job, the printer 110 prints an image corresponding to a document file onto a paper medium 111. The communications network NW1 is, for example, a local area network (LAN). Examples of the wireless communications WL1 and WL2 include short-range wireless communications, such as Wi-Fi (registered trademark) communications. Cable communications may be used instead of the wireless communications WL1 and WL2.

When the user 10 performs, on the client terminal 100, an operation for causing the multifunctional equipment 300, placed at site Y or Z where the location and region are different from those of site X, or multifunctional equipment (not illustrated), placed at site X, to print a document file, the client terminal 100 generates a print job in an intermediate format, which is not dependent on the manufacturer and the model of the multifunctional equipment 300, based on the operation. The print job in the intermediate format includes a user ID for identifying the user 10. The client terminal 100 transmits, to any of the server apparatuses 200, store-instruction data (hereinafter referred to simply as a “store instruction”) for giving an instruction for storing, in the server apparatus 200, the generated print job in the intermediate format. The store instruction includes the print job in the intermediate format. Examples of the print job in the intermediate format include a print job in an XML Paper Specification (XPS) format and a print job in an Enhanced Meta File (EMF) format. The print job in the intermediate format is hereinafter referred to as an “intermediate job”.

In this case, as illustrated in FIG. 1, the client terminal 100 and the server apparatuses 200 are connected to each other through the access point AP, the communications network NW1, and a communications network NW2. Examples of the communications network NW2 include the Internet. When the printing assisting system S is operated as the aforementioned on-premise system, a wide area network (WAN) may be used as the communications network NW2. Accordingly, the store instruction transmitted from the client terminal 100 arrives at the access point AP through the wireless communication WL1 and arrives at any of the server apparatuses 200 through the communications networks NW1 and NW2. Upon receiving the store instruction transmitted from the client terminal 100, the server apparatus 200 stores the intermediate job included in the store instruction.

Thereafter, when the user 10 moves from site X to, for example, site Y, as illustrated in FIG. 1 and performs, on the multifunctional equipment 300 placed at site Y, an operation for giving an instruction for displaying a list of intermediate jobs, the multifunctional equipment 300 transmits display-instruction data corresponding to the operation (this data is hereinafter referred to as a “display instruction”) to the server apparatus 200. Upon receiving the display instruction, the server apparatus 200 transmits the list of the stored intermediate jobs to the multifunctional equipment 300 that transmitted the display instruction.

When the user 10 selects, at the multifunctional equipment 300, at least one intermediate job from the list of intermediate jobs and performs an operation for giving an instruction for printing a document file corresponding to the selected intermediate job, the multifunctional equipment 300 transmits print-instruction data corresponding to the operation (this data is hereinafter referred to as a “print instruction”) to the server apparatus 200. Upon receiving the print instruction, the server apparatus 200 identifies the transmission source of the print instruction and the document file to be printed and converts the intermediate job corresponding to the identified document file into a rendering job that is dependent on the multifunctional equipment 300 that transmitted the print instruction. The server apparatus 200 then transmits the rendering job to the multifunctional equipment 300.

Thus, the multifunctional equipment 300 on which the user 10 performed the operation prints an image corresponding to the document file onto a paper medium (not illustrated), based on an analysis result of the rendering job. Accordingly, when a document-file intermediate job generated by the client terminal 100 is transmitted to the server apparatus 200, the user 10 does not have to carry the paper medium 111 printed at site X to site Y. As a result, it is possible to inhibit loss and theft of the paper medium 111.

Details of the printing assisting system S will be described below.

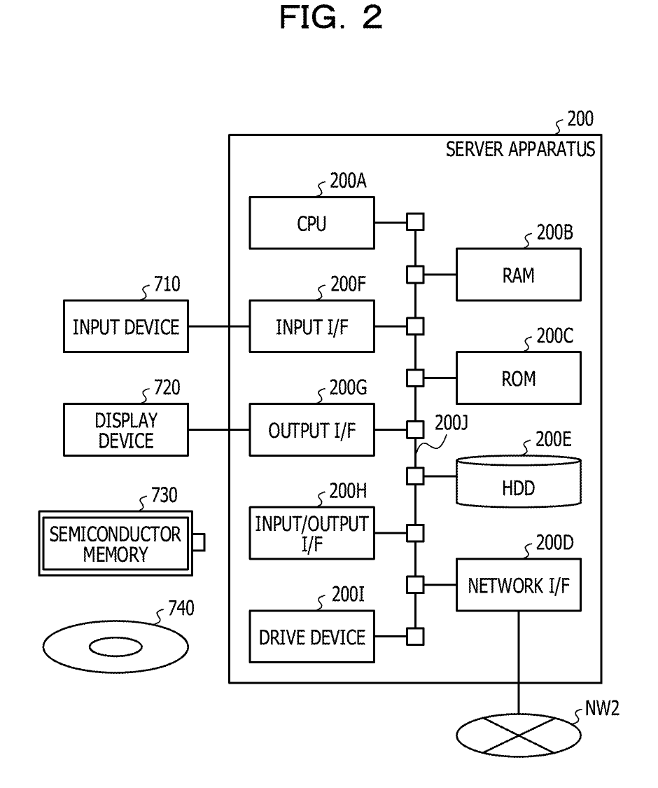

FIG. 2 illustrates an example of the hardware configuration of one server apparatus 200. Since the client terminal 100 and the multifunctional equipment 300 have hardware configurations that are basically the same as or similar to that of the server apparatus 200, descriptions thereof are not given hereinafter. As illustrated in FIG. 2, the server apparatus 200 includes at least a central processing unit (CPU) 200A, which is a hardware processor, a random-access memory (RAM) 200B, a read-only memory (ROM) 200C, and a network interface (I/F) 200D. The server apparatus 200 may further include at least one of a hard disk drive (HDD) 200E, an input I/F 200F, an output I/F 200G, an input/output I/F 200H, and a drive device 2001, as appropriate. The CPU 200A, the RAM 200B, the ROM 200C, the network I/F 200D, the HDD 200E, the input I/F 200F, the output I/F 200G, the input/output I/F 200H, and the drive device 2001 are connected to each other through an internal bus 200J. In this manner, the server apparatus 200 may also be realized by a computer. A micro processing unit (MPU), instead of the CPU 200A, may also be used as the hardware processor.

An input device 710 is connected to the input I/F 200F. Examples of the input device 710 include a keyboard and a mouse. A display device 720 is connected to the output I/F 200G. One example of the display device 720 is a liquid-crystal display. A semiconductor memory 730 is connected to the input/output I/F 200H. Examples of the semiconductor memory 730 include a Universal Serial Bus (USB) memory and a flash memory. The input/output I/F 200H reads a program and data stored in the semiconductor memory 730. The input I/F 200F and the input/output I/F 200H have, for example, USB ports. The output I/F 200G has, for example, a display port.

A portable recording medium 740 is inserted into the drive device 2001. The portable recording medium 740 is, for example, a removable disk, such as a compact disc read-only memory (CD-ROM) or a digital versatile disc (DVD). The drive device 2001 reads a program and data recorded on the portable recording medium 740. The network I/F 200D has, for example, a communication circuit and a LAN port. The network I/F 200D is connected to the above-described communications network NW2.

The CPU 200A causes the programs, stored in the ROM 200C and the HDD 200E, to be temporarily stored in the RAM 200B. The CPU 200A causes the program, recorded on the portable recording medium 740, to be temporarily stored in the RAM 200B. The CPU 200A executes the stored programs to thereby cause the CPU 200A to realize various functions described below and to execute various types of processing described below. The programs may be programs according to processing sequence diagrams described below.

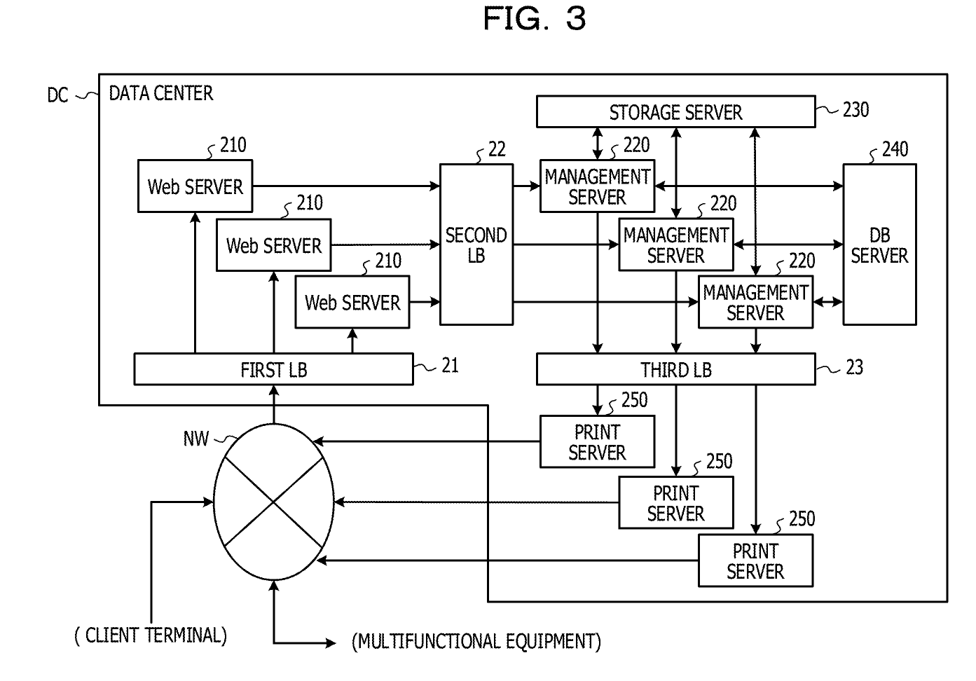

FIG. 3 is a diagram illustrating details of the data center DC according to a first embodiment. Although, in FIG. 3, example flows of data are denoted by arrows, the flows of data are not limited to the flows illustrated in FIG. 3, and there are cases in which a flow of data that is not denoted by the arrows occurs. The data center DC includes a plurality of web servers 210, a plurality of management servers 220, a storage server 230, a database (DB) server 240, a plurality of print servers 250 as the above-described server apparatuses 200. Each print server 250 corresponds to a data processing apparatus described below. The web servers 210 are arranged in parallel and have common functions. Similarly, the management servers 220 are arranged in parallel and have common functions. The print servers 250 are arranged in parallel and have common functions. The web servers 210, the management servers 220, and the print servers 250 are respectively multiplexed and made redundant. All of the web servers 210, the management servers 220, and the print servers 250 may or may not be multiplexed or made redundant, and it is sufficient that at least the print servers 250 be multiplexed or made redundant.

The data center DC further includes a first load balancer (hereinafter referred to as a “first LB”) 21, a second load balancer (hereinafter referred to as a “second LB”) 22, and a third load balancer (hereinafter referred to as a “third LB”) 23. The first LB 21, the second LB 22, and the third LB 23 may be realized by, for example, the server apparatus 200 that differs from the web servers 210, the management servers 220, the storage server 230, the DB server 240, and the print servers 250 or predetermined equipment that executes processing for distributing the amount of load. The first LB 21 distributes the amount of load applied to the web servers 210. For example, upon receiving a store instruction transmitted from the client terminal 100, the first LB 21 cyclically selects one of the web servers 210 and transmits the store instruction to the selected web server 210. The first LB 21 may monitor the amounts of load on the web servers 210 to select the web server 210 to which the least amount of load is applied. This avoids the amount of load being intensively applied to one web server 210. A case in which the first LB 21 receives a display instruction or a print instruction from the multifunctional equipment 300 is also analogous to the case in which the store instruction is received. Since the second LB 22 and the third LB 23 basically perform processing that is analogous to that of the first LB 21, a detailed description thereof is not given. Since the data center DC includes the first LB 21, the second LB 22, and the third LB 23, as described above, availability of a service to be provided by the data center DC is ensured. If only the print servers 250 are multiplexed and made redundant, it is sufficient that the data center DC have the third LB 23.

In this case, when one of the web servers 210 receives a store instruction, a display instruction, and a print instruction transmitted from the first LB21, the web server 210 transmits the received store instruction, display instruction, and print instruction to the second LB 22. Upon receiving the store instruction, display instruction, and print instruction, the second LB 22 selects one of the management servers 220 by using a scheme that is the same as or similar to that for the first LB 21 and transmits the store instruction, display instruction, and print instruction to the selected management server 220.

The management servers 220 manage the storage server 230 and the DB server 240. Upon receiving the store instruction, display instruction, and print instruction transmitted from the second LB 22, the management server 220 determines the types of instruction. Upon determining that the store instruction is received, the management server 220 stores an intermediate job, included in the store instruction, in the storage server 230. Upon determining that the display instruction is received, the management server 220 obtains a list of intermediate jobs from the storage server 230 and transmits the obtained list of intermediate jobs to the multifunctional equipment 300. Upon determining that the print instruction is received, the management server 220 registers various types of information regarding an intermediate job, included in the print instruction, in the DB server 240 as job information and/or transmits, to the third LB 23, a processing request for requesting the print server 250 to perform processing for generating a rendering job. Details of the processing that the management server 220 executes upon receiving the print instruction are described later.

Upon receiving the processing request, the third LB 23 selects one of the print servers 250 by using a scheme that is the same as or similar to that for the first LB 21 and transmits the processing request to the selected print server 250. Upon receiving the processing request transmitted from the third LB 23, the print server 250 transmits identification information (hereinafter referred to as a “server ID”), assigned to the print server 250, to the second LB 22 and/or transmits a job request for requesting an intermediate job to the management server 220. Although details are described below, when the print server 250 directly obtains an intermediate job, transmitted from the management server 220 in response to a job request, from the management server 220 without involvement of the third LB 23, the print server 250 generates a rendering job in accordance with the intermediate job, and transmits the generated rendering job to the multifunctional equipment 300 that transmitted the print instruction. Upon receiving the rendering job, the multifunctional equipment 300 executes print processing based on an analysis result of the rendering job.

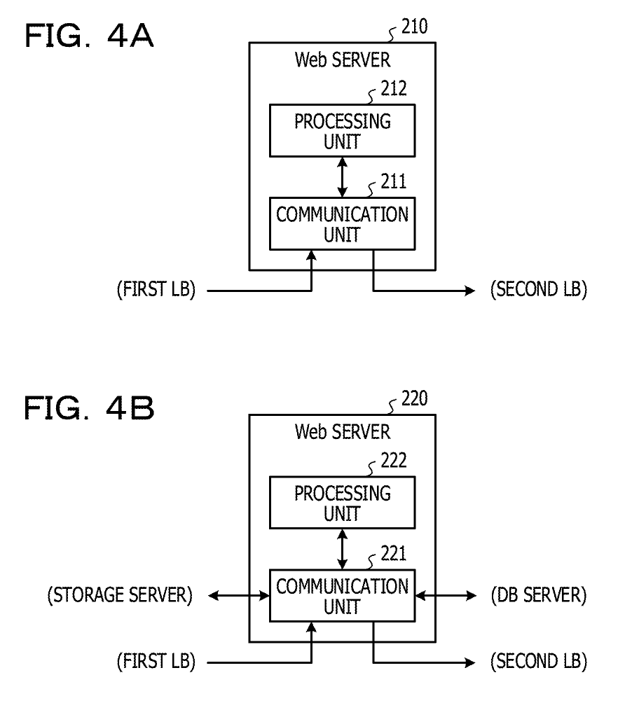

Next, functions of the web servers 210, the management servers 220, the storage server 230, the DB server 240, and the print servers 250 described above will be described with reference to FIGS. 4A to 7.

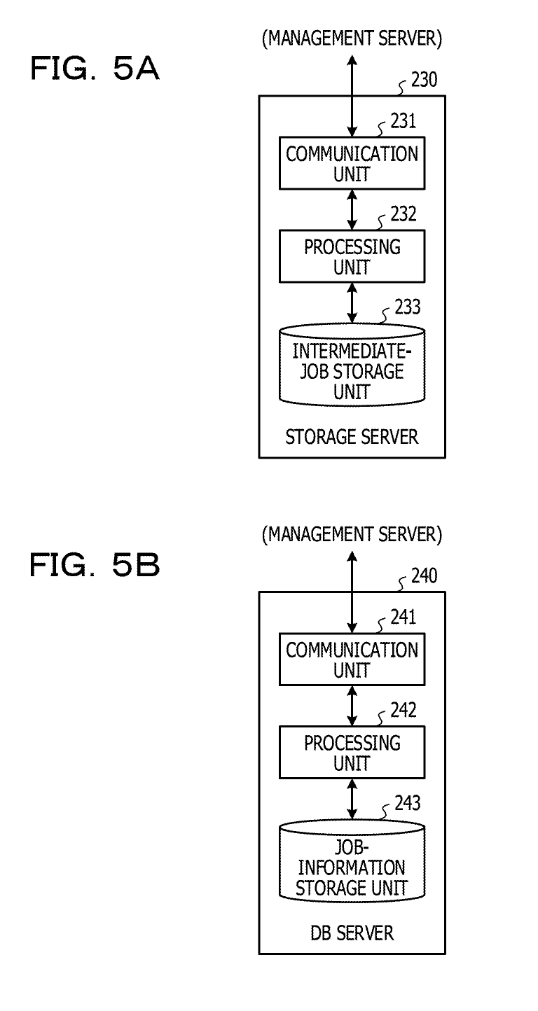

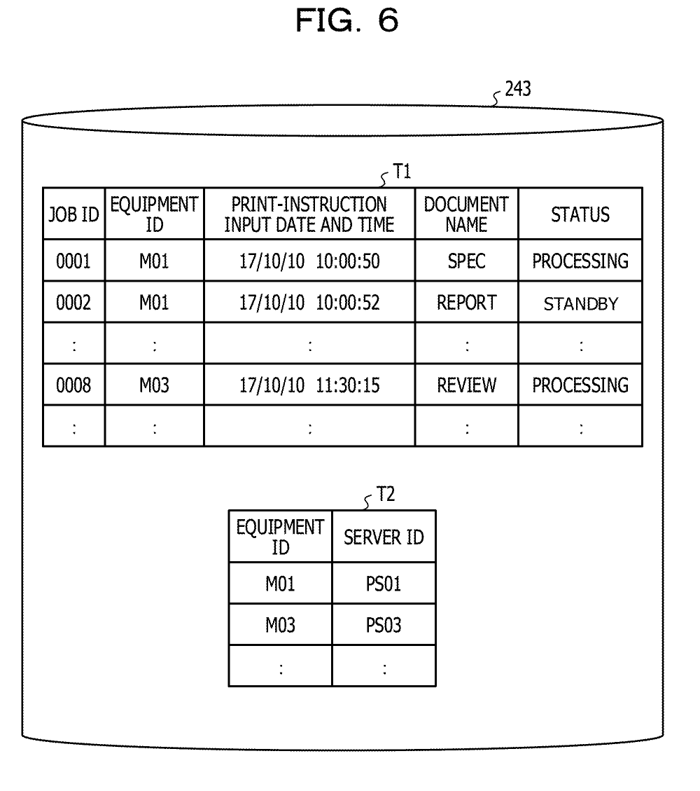

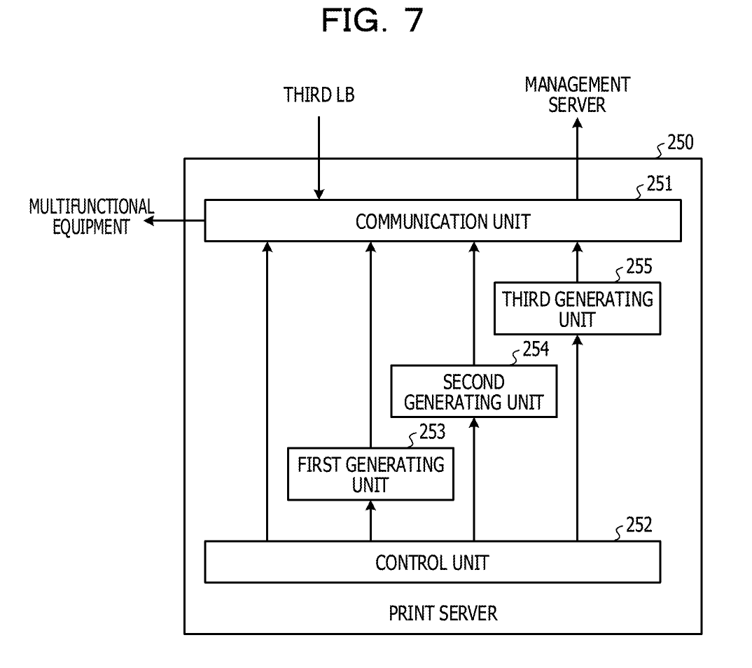

FIG. 4A is an example of a block diagram of one web server 210. FIG. 4B is an example of a block diagram of one management server 220. FIG. 5A is an example of a block diagram of the storage server 230. FIG. 5B is an example of a block diagram of the DB server 240. FIG. 6 is an example of a job-information storage unit 243. FIG. 7 is an example of a block diagram of one print server 250.

Each of communication units 211, 221, 231, 241, and 251 may be realized by the network I/F 200D described above. Each of processing units 212, 222, 232, and 242, a control unit 252, a first generating unit 253, a second generating unit 254, and a third generating unit 255 may be realized by the CPU 200A described above. Each of an intermediate job storage unit 233 and the job-information storage unit 243 may be realized by the RAM 200B or the HDD 200E described above.

First, a description will be given of the web server 210. As illustrated in FIG. 4A, the web server 210 includes the communication unit 211 and the processing unit 212. The communication unit 211 controls communication between the web server 210 and the first and second LBs 21 and 22. When the communication unit 211 receives a store instruction, a display instruction, and a print instruction transmitted from the first LB 21, the processing unit 212 executes various types of processing on the store instruction, the display instruction, and the print instruction received by the communication unit 211. Examples of the processing executed by the processing unit 212 include protocol processing regarding protocols. When the store instruction, the display instruction, and the print instruction are encrypted, the processing unit 212 may execute decoding processing for decoding the encryption. Upon finishing execution of the various types of processing on the store instruction, the display instruction, and the print instruction, the processing unit 212 transmits the processed store instruction, display instruction, and print instruction via the communication unit 211.

Next, a description will be given of the management server 220. The management server 220 includes the communication unit 221 and the processing unit 222. The communication unit 221 controls communication between the management server 220 and the second LB 22, the third LB 23, the storage server 230, and the DB server 240. Upon receiving a store instruction, a display instruction, and a print instruction transmitted from the second LB 22, the processing unit 222 determines the types of instruction and executes processing corresponding to the types of instruction.

For example, upon determining that a store instruction and/or a display instruction are/is received, the processing unit 222 transmits the store instruction and/or the display instruction to the storage server 230 via the communication unit 221. Upon determining that a print instruction is received, the processing unit 222 generates a registration instruction for giving an instruction for registering, in the DB server 240, job information included in the print instruction and/or generates a processing request for requesting the print server 250 to perform processing for generating a rendering job. Upon generating the registration instruction, the processing unit 222 transmits the registration instruction to the DB server 240 via the communication unit 221. The registration instruction includes job information. Upon generating the processing request, the processing unit 222 transmits the processing request to the third LB 23 via the communication unit 221.

Next, a description will be given of the storage server 230. The storage server 230 includes the communication unit 231, the processing unit 232, and the intermediate job storage unit 233. The communication unit 231 controls communication between the storage server 230 and the management server 220. Upon receiving a store instruction transmitted from one of the management servers 220, the processing unit 232 stores an intermediate job, included in the store instruction, in the intermediate job storage unit 233. Upon receiving a display instruction transmitted from one of the management servers 220, the processing unit 232 obtains a list of intermediate jobs stored in the intermediate job storage unit 233 and transmits the list of intermediate jobs to the management server 220 via the communication unit 231. Upon receiving the list of intermediate jobs, the management server 220 transmits the list of intermediate jobs to the multifunctional equipment 300 that transmitted the display instruction.

Next, a description will be given of the DB server 240. The DB server 240 includes the communication unit 241, the processing unit 242, and the job-information storage unit 243. The communication unit 241 controls communication between the DB server 240 and the management server 220. Upon receiving a registration instruction transmitted from one of the management servers 220, the processing unit 242 registers the job information, included in the registration instruction, in the job-information storage unit 243.

For example, as illustrated in FIG. 6, the processing unit 242 registers, in a first management table T1 in the job-information storage unit 243, an equipment ID, a print-instruction input date and time, and a document name included in the job information. The processing unit 242 may register, in the first management table T1, various types of setting information (such as black-and-white printing and color printing) set for each document file to which a document name is given. Each equipment ID is an identifier associated with the corresponding multifunctional equipment 300. Each print-instruction input date and time indicates a date and time when the user 10 performed, on the multifunctional equipment 300, an operation for giving an instruction for printing. Although each print-instruction input date and time in the units of seconds is illustrated in FIG. 6 as an example, it may be extended to the units of 0.01 second. This makes it possible to distinguish between the print instruction input dates and times even when the print instruction input dates and times are the same, as long as they are different from each other in units of 0.01 second. Each document name indicates the name of a document file that the user 10 selected as a print target. The processing unit 242 generates a job ID for identifying job information during registration of the job information and registers the generated job ID in association with the job information. The processing unit 242 periodically updates each status in accordance with the state of intermediate-job transmission performed by the management server 220.

As illustrated in FIG. 6, the processing unit 242 registers, in a second management table T2 in the job-information storage unit 243, the equipment ID included in the job information. When an equipment ID that matches an equipment ID included in job information is registered in the second management table T2, the processing unit 242 suspends registration of the equipment ID in the second management table T2. This avoids the equipment ID being duplicated in the second management table T2. The processing unit 242 registers a server ID in the second management table T2 at a predetermined timing. Processing performed when the processing unit 242 registers the server ID is described later.

Each print server 250 will be described next. Each print server 250 includes the communication unit 251, the control unit 252, the first generating unit 253, the second generating unit 254, and the third generating unit 255. The communication unit 251 controls communication between the print server 250 and the third LB 23 and communication between the print server 250 and the multifunctional equipment 300. Upon receiving a processing request transmitted from the third LB 23 via the communication unit 251, the control unit 252 transmits the server ID of the print server 250 to the management server 220 that transmitted the processing request.

Although details are described later, when the control unit 252 receives an intermediate job from the management server 220 that transmitted a processing request, the control unit 252 selects one of the first generating unit 253, the second generating unit 254, and the third generating unit 255 which corresponds to the intermediate job. The control unit 252 outputs the intermediate job to the selected first generating unit 253, second generating unit 254, or third generating unit 255. Each of the first generating unit 253, the second generating unit 254, and the third generating unit 255 generates a rendering job corresponding to the model or the manufacturer of the multifunctional equipment 300 in accordance with the intermediate job. Each of the first generating unit 253, the second generating unit 254, and the third generating unit 255 may be realized by a printer driver corresponding to the model or the manufacturer of the multifunctional equipment 300. For example, when an intermediate job is input to the second generating unit 254, the second generating unit 254 generates a rendering job in accordance with the intermediate job and transmits the generated rendering job to the multifunctional equipment 300 via the communication unit 251.

Next, a description will be given of the operation of the printing assisting system S.

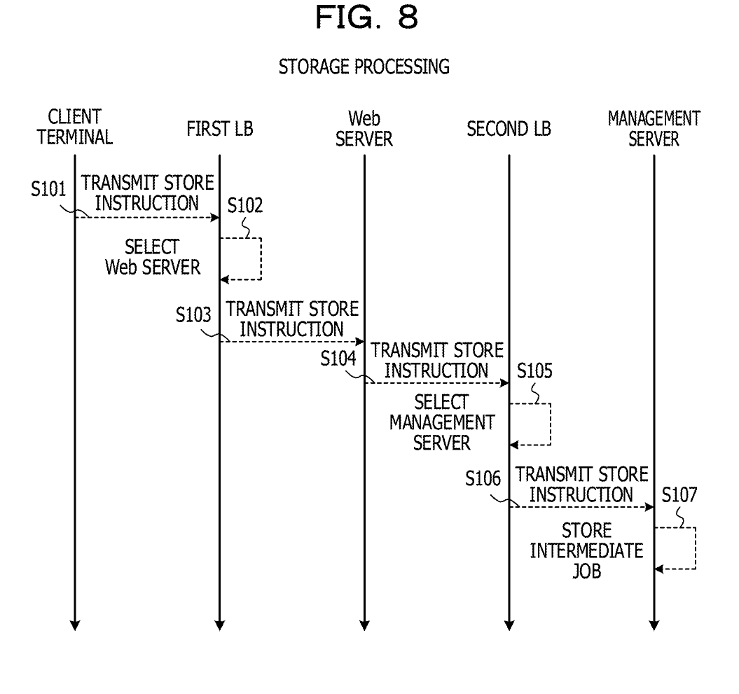

First, storage processing for storing an in intermediate job in the storage server 230 will be described with reference to FIG. 8. FIG. 8 is a processing sequence diagram illustrating an example of the storage processing. The client terminal 100 transmits a store instruction to the first LB 21 (step S101). For example, a control unit (not illustrated) included in the client terminal 100 transmits a store instruction to the first LB 21. As described above, the store instruction includes an intermediate job. When the client terminal 100 transmits the store instruction, the first LB 21 receives the store instruction and selects one of the web servers 210 (step S102). Upon selecting one of the web servers 210, the first LB 21 transmits the store instruction to the selected web server 210 (step S103).

The web server 210 receives the store instruction transmitted from the first LB 21. For example, the processing unit 212 in the web server 210 receives the store instruction via the communication unit 211. Upon receiving the store instruction, the web server 210 transmits the received store instruction to the second LB 22 (step S104). For example, upon receiving the store instruction, the processing unit 212 in the web server 210 transmits the received store instruction to the second LB 22 via the communication unit 211. When the web server 210 transmits the store instruction, the second LB 22 receives the store instruction and selects one of the management servers 220 (step S105). Upon selecting one of the management servers 220, the second LB 22 transmits the store instruction to the selected management server 220 (step S106).

The management server 220 receives the store instruction transmitted from the second LB 22. For example, the processing unit 222 in the management server 220 receives the store instruction, transmitted from the second LB 22, via the communication unit 221. Upon receiving the store instruction, the management server 220 stores the intermediate job, included in the store instruction, in the storage server 230 (step S107). For example, upon receiving the store instruction, the processing unit 222 in the management server 220 transmits the received store instruction to the storage server 230, and upon receiving the store instruction, the processing unit 232 in the storage server 230 stores the intermediate job, included in the received store instruction, in the intermediate job storage unit 233. As a result, the intermediate job generated by the client terminal 100 is accumulated in the intermediate job storage unit 233. Although an example in which the client terminal 100 transmits a store instruction including an intermediate job, and the management server 220 stores the intermediate job, included in the store instruction, in the storage server 230 has been described above in the present embodiment, the present disclosure is not limited to such an example. For example, a control unit (not illustrated) in the client terminal 100 may separately transmit a store instruction including an intermediate job and a store instruction not including an intermediate job at different timings. In this case, upon receiving the intermediate job transmitted from the client terminal 100, the processing unit 222 in the management server 220 transmits the received intermediate job to the storage server 230. Upon receiving the intermediate job, the processing unit 232 in the storage server 230 holds the received intermediate job until receiving a store instruction. Accordingly, intermediate jobs stay in the storage server 230. Thereafter, upon receiving the store instruction transmitted from the client terminal 100, the processing unit 222 in the management server 220 transmits the received store instruction to the storage server 230. Upon receiving the store instruction, the processing unit 232 in the storage server 230 collectively stores the held intermediate jobs in the intermediate job storage unit 233. Such a storage scheme may also be employed.

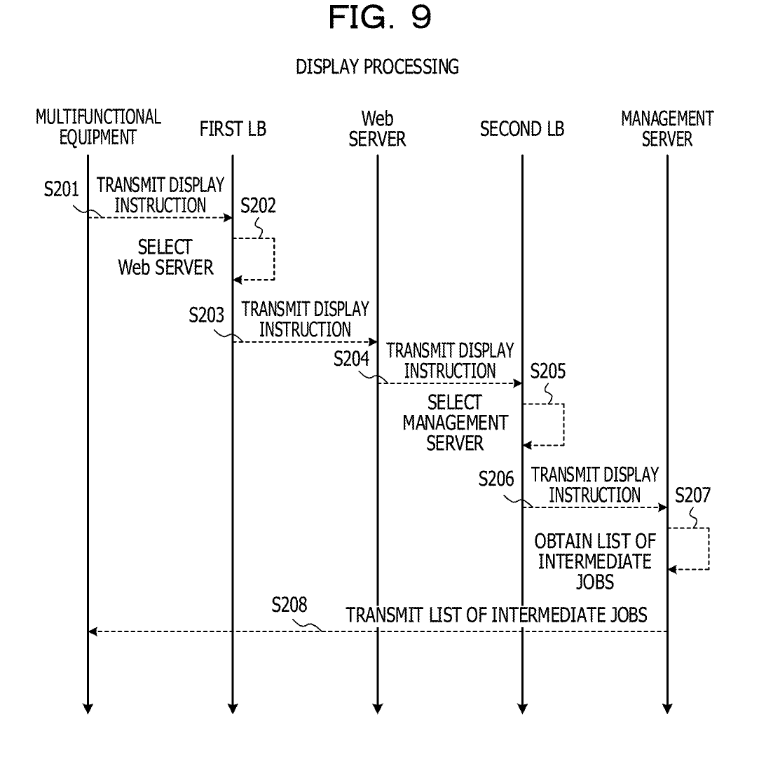

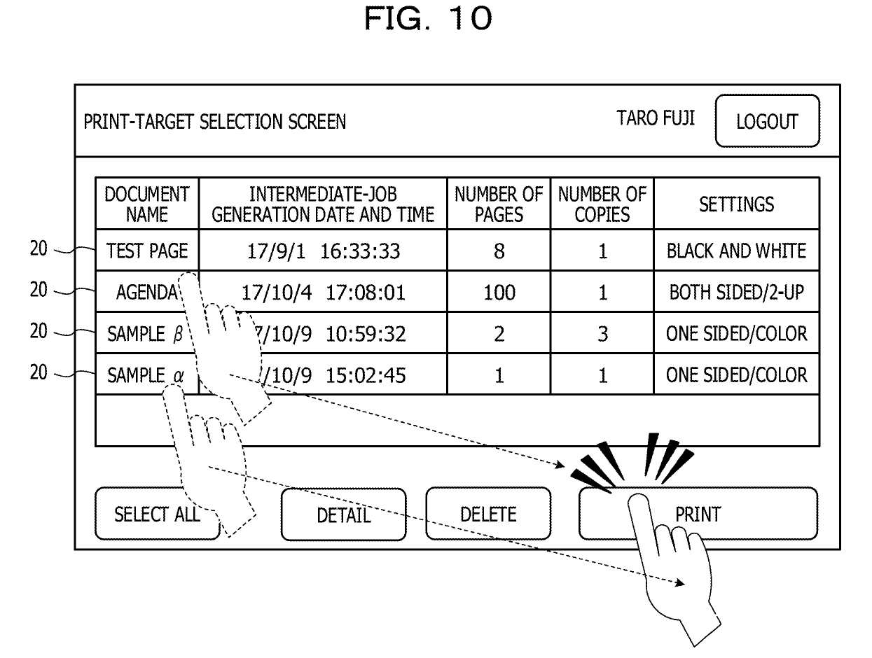

Next, display processing in which a list of intermediate jobs is displayed on the multifunctional equipment 300 will be described with reference to FIGS. 9 and 10.

FIG. 9 is a processing sequence diagram illustrating an example of the display processing. FIG. 10 illustrates an example of a print-target selection screen. First, as illustrated in FIG. 9, the multifunctional equipment 300 transmits a display instruction to the first LB 21 (step S201). As described above, when the user 10 performs, on the multifunctional equipment 300, an operation (for example, a login operation) for giving an instruction for displaying a list of intermediate jobs, a control unit (not illustrated) included in the multifunctional equipment 300 transmits a display instruction to the first LB 21. The display instruction includes a user ID for identifying the user 10. When the multifunctional equipment 300 transmits the display instruction, the first LB 21 receives the display instruction and selects one of the web servers 210 (step S202). Upon selecting one of the web servers 210, the first LB 21 transmits the display instruction to the selected web server 210 (step S203).

The web server 210 receives the display instruction transmitted from the first LB 21. For example, the processing unit 212 in the web server 210 receives the display instruction via the communication unit 211. Upon receiving the display instruction, the web server 210 transmits the received display instruction to the second LB 22 (step S204). For example, upon receiving the display instruction, the processing unit 212 in the web server 210 transmits the received display instruction to the second LB 22 via the communication unit 211. When the web server 210 transmits the display instruction, the second LB 22 receives the display instruction and selects one of the management servers 220 (step S205). Upon selecting one of the management servers 220, the second LB 22 transmits the display instruction to the selected management server 220 (step S206).

The management server 220 receives the display instruction transmitted from the second LB 22. For example, the processing unit 222 in the management server 220 receives the display instruction, transmitted from the second LB 22, via the communication unit 221. Upon receiving the display instruction, the management server 220 obtains a list of intermediate jobs from the storage server 230 (step S207). For example, upon receiving the display instruction, the processing unit 222 in the management server 220 transmits the received display instruction to the storage server 230. Upon receiving the display instruction, the processing unit 232 in the storage server 230 obtains, from the intermediate job storage unit 233, intermediate jobs corresponding to the user ID included in the received display instruction, based on the user ID, and transmits the intermediate jobs to the processing unit 222 in the management server 220. As a result, the management server 220 obtains the list of intermediate jobs from the storage server 230.

Upon obtaining the list of intermediate jobs, the management server 220 transmits the list of intermediate jobs to the multifunctional equipment 300 (step S208). For example, the processing unit 222 in the management server 220 transmits the list of intermediate jobs via the communication unit 221. As a result, a list of intermediate jobs 20 corresponding to the operation performed by the user 10 is displayed on a display unit (not illustrated) of the multifunctional equipment 300, as illustrated in FIG. 10. For example, as illustrated in FIG. 10, the user 10 may select any of the intermediate jobs 20 as a print target and perform an operation for giving an instruction for printing a document file corresponding to the selected intermediate job.

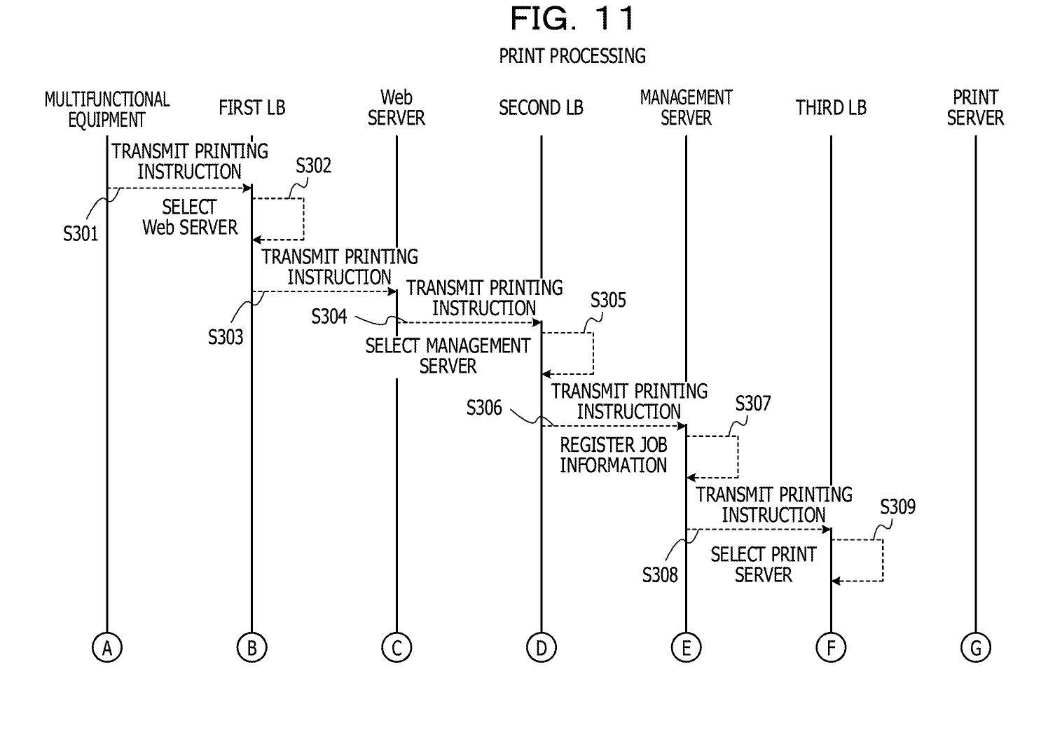

Next, print processing performed by the multifunctional equipment 300 will be described with reference to FIGS. 11 to 14C.

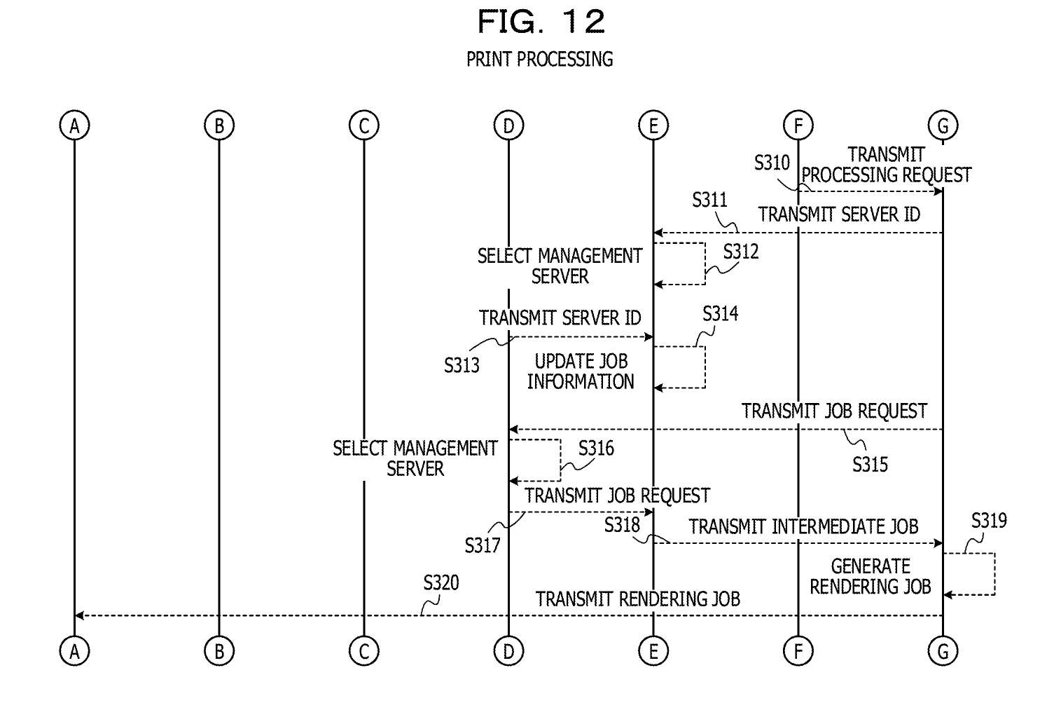

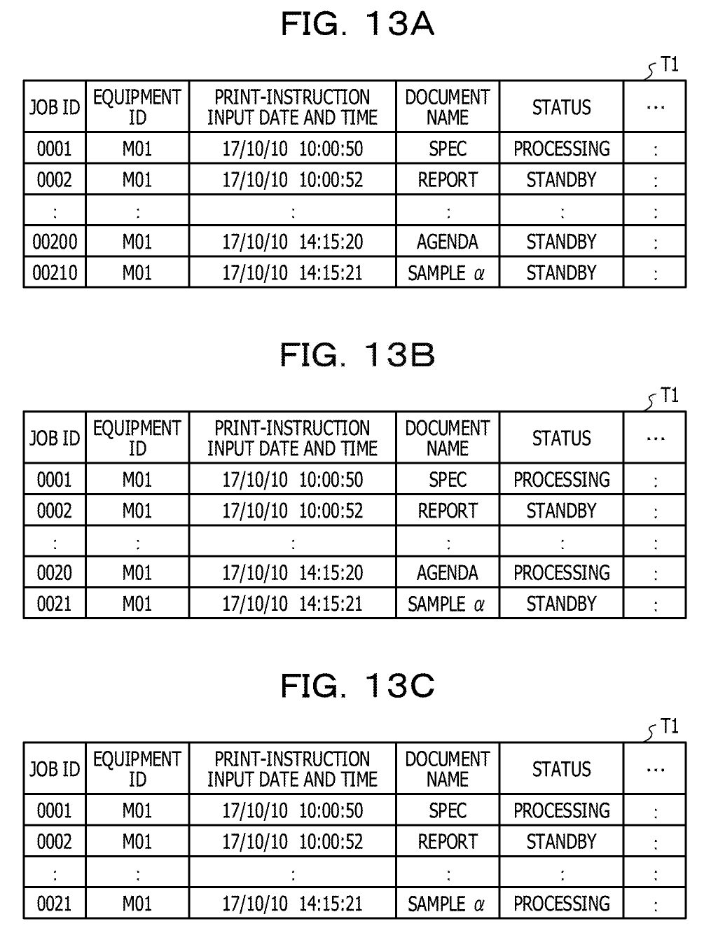

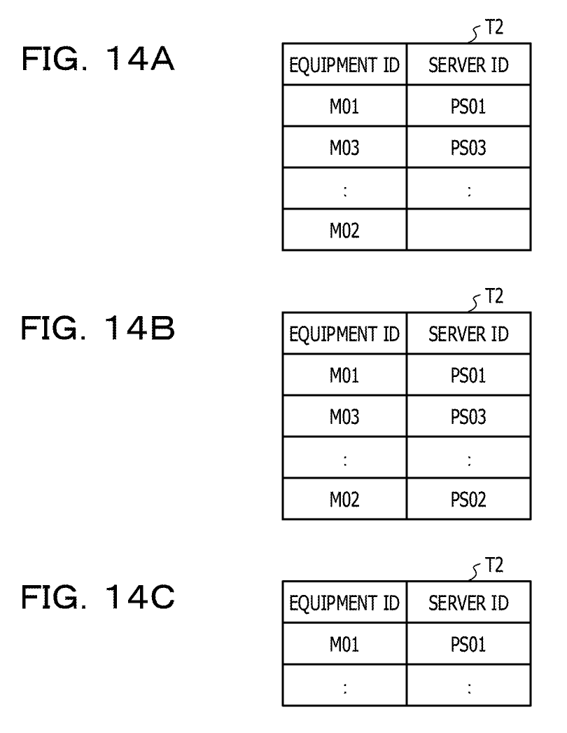

FIG. 11 is a processing sequence diagram (part 1) illustrating an example of print processing according to the first embodiment. FIG. 12 is a processing sequence diagram (part 2) illustrating the example of the print processing according to the first embodiment. FIGS. 13A to 13C illustrate an example of the first management table T1. FIGS. 14A to 14C illustrate an example of the second management table T2. The processing sequence diagram (part 1) in FIG. 11 is continuous to the processing sequence diagram (part 2) in FIG. 12 via corresponding symbols (symbols “A” to “G”).

As illustrated in FIG. 11, first, the multifunctional equipment 300 transmits a print instruction to the first LB 21 (step S301). When the user 10 performs an operation for giving an instruction for printing a document file corresponding to a selected intermediate job, the control unit (not illustrated) included in the multifunctional equipment 300 transmits a print instruction to the first LB 21, as described above. The print instruction includes job information regarding the selected intermediate job. The print instruction also includes, in conjunction with the job information, a print-instruction input date and time and the equipment ID of the multifunctional equipment 300 to which the operation was input. When the multifunctional equipment 300 transmits the print instruction, the first LB 21 receives the print instruction and selects one of the web servers 210 (step S302). Upon selecting one of the web servers 210, the first LB 21 transmits the print instruction to the selected web server 210 (step S303).

The web server 210 receives the print instruction transmitted from the first LB 21. For example, the processing unit 212 in the web server 210 receives the print instruction via the communication unit 211. Upon receiving the print instruction, the web server 210 transmits the received print instruction to the second LB 22 (step S304). For example, upon receiving the print instruction, the processing unit 212 in the web server 210 transmits the received print instruction to the second LB 22 via the communication unit 211. When the web server 210 transmits the print instruction, the second LB 22 receives the print instruction and selects one of the management servers 220 (step S305). Upon selecting one of the management servers 220, the second LB 22 transmits the print instruction to the selected management server 220 (step S306).

The management server 220 receives the print instruction transmitted from the second LB 22. For example, the processing unit 222 in the management server 220 receives the print instruction, transmitted from the second LB 22, via the communication unit 221. Upon receiving the print instruction, the management server 220 registers the job information in the DB server 240 (step S307). For example, upon receiving the print instruction, the processing unit 222 in the management server 220 transmits the received print instruction to the DB server 240. Upon receiving the print instruction, the processing unit 242 in the DB server 240 registers the job information, the print-instruction input date and time, and the equipment ID, included in the received print instruction, in the job-information storage unit 243 in association with each other.

As a result, for example, as illustrated in FIG. 13A, job information regarding a document name “agenda” selected on a print target selection screen and job information regarding a document name “sample α”, together with an equipment ID “M02” and print-instruction input dates and times “17/10/10 14:15:20” and “17/10/10 14:15:21” associated with the job information, are registered in the first management table T1. As illustrated in FIG. 14A, the equipment ID “M02” of the multifunctional equipment 300 on which the user 10 performed an operation for giving an instruction for printing the document file corresponding to the selected intermediate job is registered in the second management table T2.

Referring back to FIG. 11, when the management server 220 registers the job information, the management server 220 transmits a processing request to the third LB 23 (step S308). For example, the processing unit 222 in the management server 220 transmits the processing request via the communication unit 221. The processing request includes the equipment ID. When the management server 220 transmits the processing request, the third LB 23 receives the processing request and selects one of the print servers 250 (step S309). Upon selecting one of the print servers 250, the third LB 23 transmits the processing request to the selected print server 250, as illustrated in FIG. 12 (step S310).

The print server 250 receives the processing request transmitted from the third LB 23. For example, the control unit 252 in the print server 250 receives the processing request, transmitted from the third LB 23, via the communication unit 251. Upon receiving the processing request, the print server 250 transmits a server ID to the second LB 22 (step S311). For example, the control unit 252 in the print server 250 transmits a server ID, assigned to the print server 250, to the second LB 22 via the communication unit 251. The control unit 252 may transmit the server ID to the first LB 21.

When the print server 250 transmits the server ID, the second LB 22 receives the server ID and selects one of the management servers 220 (step S312). Upon selecting one of the management servers 220, the second LB 22 transmits the server ID to the selected management server 220 (step S313).

The management server 220 receives the server ID transmitted from the second LB 22. For example, the processing unit 222 in the management server 220 receives the server ID, transmitted from the second LB 22, via the communication unit 221. Upon receiving the server ID, the management server 220 updates the job information registered in the DB server 240 (step S314). For example, upon receiving the server ID, the processing unit 222 in the management server 220 transmits the received server ID to the DB server 240. Upon receiving the server ID, the processing unit 242 in the DB server 240 updates the job-information storage unit 243, based on the received server ID.

For example, the processing unit 242 identifies an equipment ID with which the server ID is not associated in the second management table T2, and associates the received server ID with the identified equipment ID. As a result, as illustrated in FIG. 14B, a server ID “PS02” transmitted from the print server 250 is associated with the equipment ID “M02” already registered in the second management table T2. Thus, it is determined that the print server 250 to which the server ID “PS02” is assigned is mainly responsible for generating a rendering job to be transmitted to the multifunctional equipment 300 to which the equipment ID “M02” is assigned.

When a predetermined setting time passes after the print server 250 executes the process in steps S311, the print server 250 transmits, to the second LB 22, a job request for requesting an intermediate job, as illustrated in FIG. 12 (step S315). The job request includes both the server ID of the source of the job request and the equipment ID of the multifunctional equipment 300 on which the user 10 performed the operation. The job request may include one of the server ID and the equipment ID. It is desirable that the aforementioned setting time be a sufficiently large amount of time within which the processes in steps S312 to S314 are completed. Instead of using the setting time, the print server 250 may periodically execute palling for inquiring the management server 220 about whether or not the process in steps S314 is completed, and when the process in steps S314 is completed, the print server 250 may execute the process in steps S315.

When the print server 250 transmits the job request, the second LB 22 receives the job request and selects one of the management servers 220 (step S316). Upon selecting one of the management servers 220, the second LB 22 transmits the job request to the selected management server 220 (step S317).

The management server 220 receives the job request transmitted from the second LB 22. For example, the processing unit 222 in the management server 220 receives the job request, transmitted from the second LB 22, via the communication unit 221. Upon receiving the job request, the management server 220 transmits the intermediate job stored in the storage server 230 to the print server 250 without involvement of the third LB 23 (step S318). For example, upon receiving the job request, the processing unit 222 in the management server 220 transmits the received job request to the DB server 240. Upon receiving the job request, the processing unit 242 in the DB server 240 obtains job information from the job-information storage unit 243, based on the received job request.

For example, based on the equipment ID included in the job request, the processing unit 242 identifies, in the first management table T1, job information that is included in job information corresponding to the equipment ID and whose print-instruction input date and time is the earliest. Also, based on the equipment ID included in the job request, the processing unit 232 identifies, in the second management table T2, a server ID corresponding to the equipment ID. The processing unit 242 transmits the identified job information and server ID to the management server 220 via the communication unit 241.

Upon receiving the job information and the server ID, the management server 220 obtains an intermediate job from the storage server 230, based on the received job information. For example, the processing unit 222 in the management server 220 generates an obtain request including the received job information and transmits the obtain request to the storage server 230, and based on the job information included in the obtain request, the processing unit 232 in the storage server 230 obtains, from the intermediate job storage unit 233, an intermediate job corresponding to the job information. Since the job information includes at least a document name, the processing unit 232 may obtain, from the intermediate job storage unit 233, an intermediate job corresponding to the document name. Upon obtaining the intermediate job, the processing unit 232 transmits the intermediate job to the management server 220 via the communication unit 231. The management server 220 obtains the intermediate job. Upon obtaining the intermediate job, the management server 220 associates the equipment ID with the obtained intermediate job. The management server 220 transmits the intermediate job with which the equipment ID is associated to the print server 250 having the server ID received from the DB server 240.

Upon transmitting the intermediate job, the management server 220 updates the DB server 240. For example, the processing unit 222 in the management server 220 transmits, to the DB server 240, an update request for updating job information corresponding to the transmitted intermediate job. Upon receiving the update request, the processing unit 242 in the DB server 240 changes the status of the job information corresponding to the intermediate job transmitted to the print server 250 from “standby” to “processing”, based on the received update request, as illustrated in FIG. 13B.

Upon receiving the intermediate job transmitted from the management server 220, the print server 250 generates a rendering job in accordance with the received intermediate job (step S319). For example, upon receiving the intermediate job via the communication unit 251, the control unit 252 in the print server 250 selects one of the first generating unit 253, the second generating unit 254, and the third generating unit 255 which corresponds to the equipment ID associated with the intermediate job.

For example, in a case in which the first generating unit 253 generates a rendering job that is processable by the multifunctional equipment 300 having an equipment ID “M01”, the second generating unit 254 generates a rendering job that is processable by the multifunctional equipment 300 having the equipment ID “M02”, and the third generating unit 255 generates a rendering job that is processable by the multifunctional equipment 300 having an equipment ID “M03”, when the control unit 252 receives an intermediate job associated with the equipment ID “M02”, the control unit 252 selects the second generating unit 254, based on the equipment ID “M02”.

Upon selecting one of the first generating unit 253, the second generating unit 254, and the third generating unit 255, the control unit 252 transmits the intermediate job to the selected first generating unit 253, second generating unit 254, or third generating unit 255. For example, when the control unit 252 selects the second generating unit 254, the control unit 252 transmits the intermediate job to the selected second generating unit 254. As a result, the second generating unit 254 generates a rendering job in accordance with the intermediate job.

As illustrated in FIG. 12, when the print server 250 finishes generating the rendering job, the print server 250 transmits the generated rendering job to the multifunctional equipment 300 (step S320). For example, when the second generating unit 254 finishes generating the rendering job, the second generating unit 254 transmits the rendering job to the multifunctional equipment 300 via the communication unit 251. The second generating unit 254 transmits the rendering job to the multifunctional equipment 300 having the equipment ID associated with the intermediate job. This allows the multifunctional equipment 300 to print, on a paper medium, an image corresponding to the received rendering job.

When the print server 250 transmits the rendering job, the print server 250 transmits an update request for requesting update of the job information to the management server 220. Upon receiving the update request, the processing unit 222 in the management server 220 deletes, from the first management table T1, the job information corresponding to the intermediate job transmitted to the print server 250, based on the received update request, as illustrated in FIG. 13C. Upon transmitting the rendering job, the print server 250 executes the process in steps S315 again. Thus, the print server 250 transmits a job request to the management server 220 and issues a request for a next intermediate job corresponding to a printing order and different from the already received intermediate job. As a result, the print server 250 receives the next intermediate job and generates a rendering job in accordance with the received next intermediate job. Since the print server 250 that generates the rendering job in accordance with the intermediate job is uniquely identified using the second management table T2, the next intermediate job is also received by the print server 250 that processed the previous intermediate job. Hence, the next intermediate job is not received by the print server 250 that is different from the print server 250 that processed the previous intermediate job. The print server 250 generates a next rendering job in accordance with the next intermediate job and transmits the generated next rendering job to the multifunctional equipment 300.

Thus, a rendering job corresponding to the previously processed intermediate job is transmitted to the multifunctional equipment 300, and a next rendering job corresponding to the next intermediate job according to a printing order is transmitted to the multifunctional equipment 300. Accordingly, in the multifunctional equipment 300, variations in the printing order do not occur, and the printing order is ensured. When the processing unit 222 in the management server 220 receives the update request and determines that the job information corresponding to the intermediate job transmitted to the print server 250 does not exist in the first management table T1, the processing unit 222 deletes information corresponding to the equipment ID from the second management table T2, as illustrated in FIG. 14C.

According to the first embodiment, the print server 250 includes the control unit 252, as described above. When the control unit 252 receives the equipment ID associated with the multifunctional equipment 300, the control unit 252 transmits, to the management server 220 that manages intermediate jobs, a job request for requesting at least one of intermediate jobs corresponding to rendering jobs to be transmitted to the multifunctional equipment 300. After the control unit 252 receives at least one intermediate job or transmits a rendering job, the control unit 252 transmits, to the management server 220, a job request for requesting an intermediate job that is included in the intermediate jobs corresponding to the rendering jobs to be transmitted to the multifunctional equipment 300 and that is different from the at least one intermediate job. Thus, variations in the printing order do not occur.

### Second Embodiment

A second embodiment of the present disclosure will be described next.

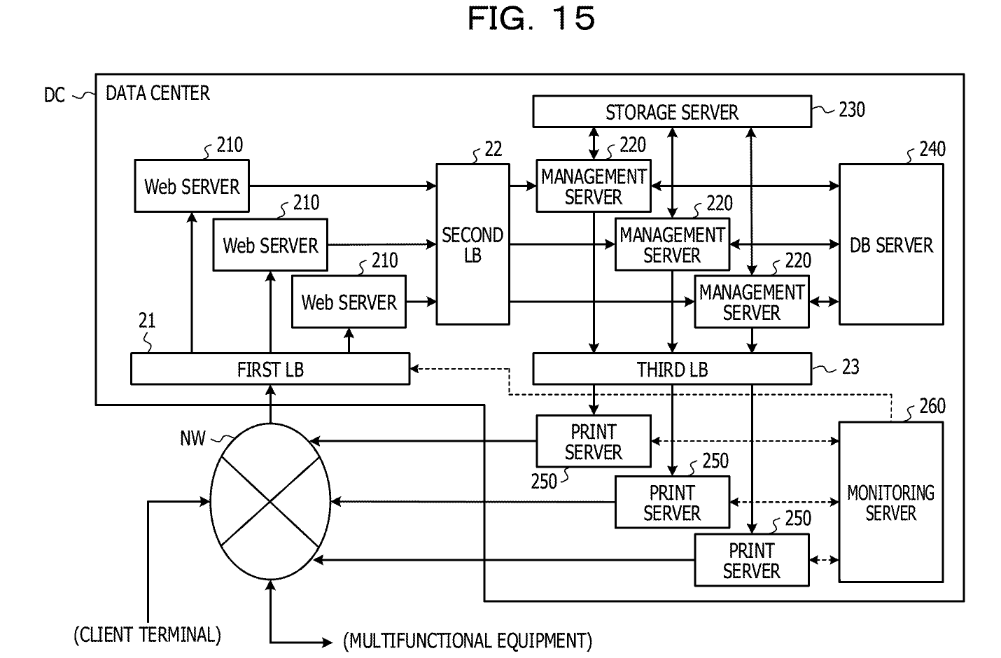

FIG. 15 is a diagram illustrating details of a data center DC according to the second embodiment. As illustrated in FIG. 15, the second embodiment differs from the first embodiment in that the data center DC further includes a monitoring server 260 as a server apparatus 200. The monitoring server 260 monitors the print servers 250. Upon detecting that a failure occurs in any of the print servers 250, the monitoring server 260 issues a notification indicating the failure in the print server 250 to any of the management server 220 via the first LB 21. In response to the notification, the management server 220 transmits, to the print server 250 that has no failure, a processing request that is the same as or similar to a processing request transmitted to the print server 250 that has the failure. As a result, the print server 250 that receives the processing request may execute processing that is analogous to processing executed by the print server 250 that has a failure and may continue the transmission of a rendering job to the multifunctional equipment 300. Examples of the failure include server down, process down, network failure, and slowing down.

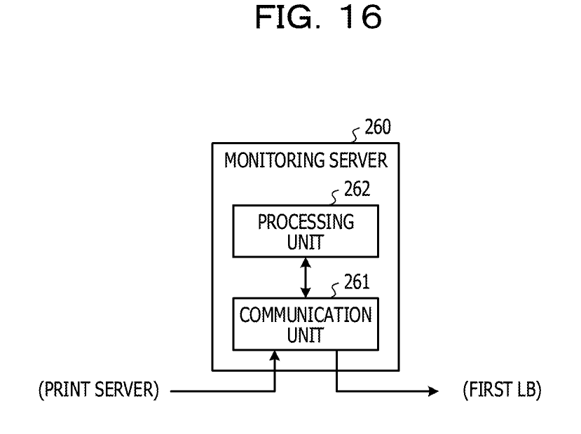

FIG. 16 is an example of a block diagram of the monitoring server 260. The monitoring server 260 includes a communication unit 261 and a processing unit 262. The communication unit 261 may be realized by the network I/F 200D described above. The processing unit 262 may be realized by the CPU 200A described above.

The communication unit 261 controls communication between the monitoring server 260 and the print server 250 and communication between the monitoring server 260 and the first LB 21. The processing unit 262 monitors the print server 250, and upon detecting that the print server 250 has a failure, the processing unit 262 issues a notification indicating the failure in the print server 250.

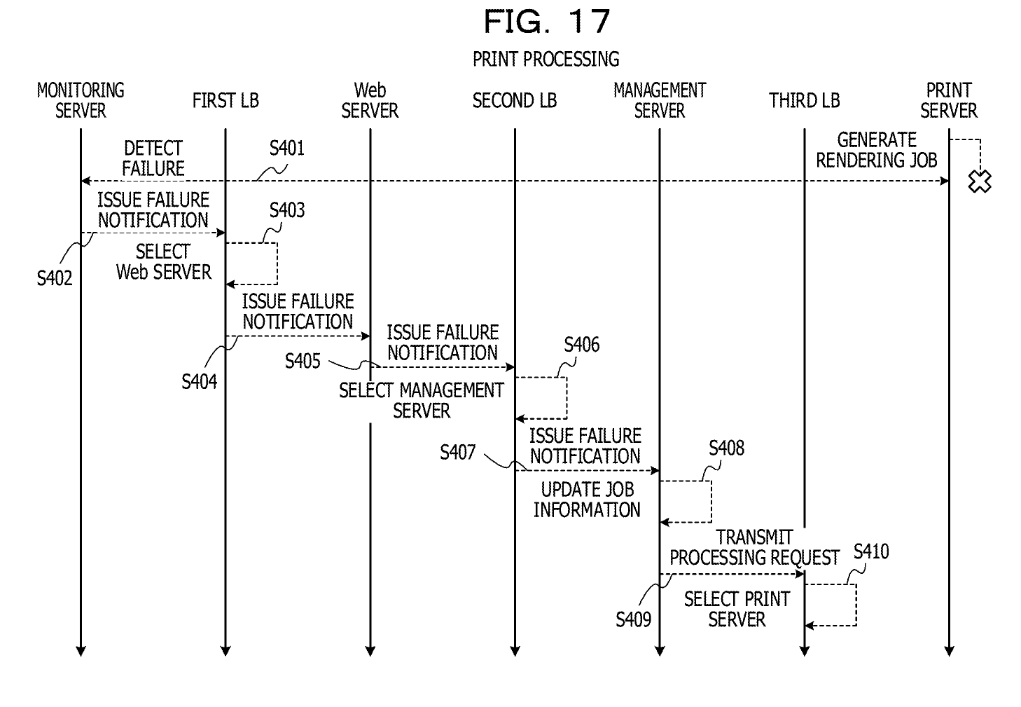

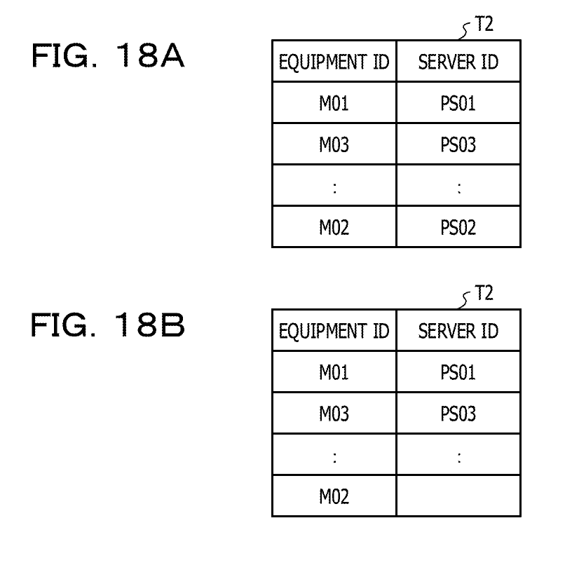

Next, print processing performed by the multifunctional equipment 300 will be described with reference to FIGS. 17, 18A, and 18B.

FIG. 17 is a processing sequence diagram illustrating an example of print processing according to the second embodiment. FIGS. 18A and 18B illustrate another example of the second management table T2. First, as illustrated in FIG. 17, when a failure occurs in one of the print servers 250 while the print server 250 is generating a rendering job, the monitoring server 260 detects the failure in the print server 250 (step S401). For example, the processing unit 262 in the monitoring server 260 detects the failure in the print server 250.

Upon detecting the failure in the print server 250, the monitoring server 260 issues a notification indicating the failure to the first LB 21 (step S402). Upon receiving the notification indicating the failure, the first LB 21 selects one of the web servers 210 (step S403). Upon selecting one of the web servers 210, the first LB 21 issues a notification indicating the failure to the selected web server 210 (step S404).

Upon receiving the notification indicating the failure, the web server 210 issues a notification indicating the failure to the second LB 22 (step S405). Upon receiving the notification indicating the failure, the second LB 22 selects one of the management servers 220 (step S406). Upon selecting one of the management servers 220, the second LB 22 issues a notification indicating the failure to the selected management server 220 (step S407).

Upon receiving the notification indicating the failure, the management server 220 updates job information registered in the DB server 240 (step S408). For example, upon receiving the notification indicating the failure, the processing unit 222 in the management server 220 transmits, to the DB server 240, the server ID of the print server 250 in which the failure occurred. Upon receiving the server ID, the processing unit 242 in the DB server 240 updates the job-information storage unit 243, based on the received server ID.

For example, when a failure occurs in the print server 250 having the server ID “PS02”, and the server ID “PS02” is associated with the equipment ID “M02”, as illustrated in FIG. 18A, the processing unit 242 deletes the server ID “PS02” associated with the equipment ID “M02”, as illustrated in FIG. 18B. Before or after deleting the server ID “PS02”, the processing unit 242 changes the status of the job information corresponding to the equipment ID “M02” from “processing” or “standby” to “error”.

Referring back to FIG. 17, when the management server 220 updates the job information, the management server 220 transmits a processing request to the third LB 23 (step S409). For example, the processing unit 222 in the management server 220 transmits the processing request via the communication unit 221. When the management server 220 transmits the processing request, the third LB 23 receives the processing request and selects one of the print servers 250 (step S410). For example, the third LB 23 selects one of the print servers 250 that do not have a failure. Upon selecting one of the print servers 250 that do not have a failure, the third LB 23 transmits the processing request to the selected print server 250. Thereafter, the print server 250 and so on execute processing that is analogous to the processing described above with reference to FIG. 12. The management server 220 may issue a notification indicating that a failure occurred in the print server 250 to the multifunctional equipment 300 to display the notification, without dynamically transmitting the processing request to the third LB 23 based on update of the job information, and may prompt the user 10 so as to re-perform the operation for giving an instruction for printing a document file corresponding to a selected intermediate job.

According to the second embodiment, even when a failure occurs in the print server 250 that is generating a rendering job, the monitoring server 260 issues a notification indicating the failure in the print server 250 to any of the management servers 220. This allows the management server 220 to cause another print server 250 that has no failure to generate a rendering job and allows the multifunctional equipment 300 to continue the print processing based on the rendering job generated by the print server 250. Although, in the second embodiment, the monitoring server 260 having the functions that are different from those of the print server 250 is provided at the data center DC, the web server 210 or the third LB 23 that has functions different from those of the print server 250, another print server 250 that has no failure, or the management server 220 may execute processing that is analogous to the processing executed by the monitoring server 260, and the monitoring server 260 may be omitted from the data center DC. In this case, since the third LB 23 transmits the processing request after checking the processing states of the print servers 250, it is efficient that the third LB 23 execute processing that is analogous to the processing executed by the monitoring server 260.

Although some preferred embodiments have been described above, the present disclosure is not limited to the particular embodiments, and various changes and modifications are possible within the spirit and scope of the present disclosure recited in the claims. For example, although, in the first and second embodiments described above, the print server 250 obtains one intermediate job based on a job request transmitted thereby, for example, the print server 250 may obtain two intermediate jobs based on a job request. The print server 250 may issue a request for at least one intermediate job to the management server 220.

Although, in the first and second embodiments described above, the multifunctional equipment 300 is used as one example of image forming apparatuses, printers may also be used instead of the multifunctional equipment 300. In this case, since printers do not have operable display units in many cases, a printer that is to execute print processing may be determined at a timing when the client terminal 100 generates an intermediate job. When the client terminal 100 generates an intermediate job, the client terminal 100 transmits a store instruction including the intermediate job to any of the management servers 220, and the management server 220 stores the intermediate job, as described above with reference to FIG. 8. Thereafter, the management server 220, the print server 250, and so on execute processing that is analogous to the processing described above with reference to FIGS. 11 and 12, to thereby make it possible to ensure a printing order in each printer, as in the multifunctional equipment 300.

Although, in the first and second embodiments described above, the print server 250 transmits a job request, and the management server 220 that receives the job request transmits an intermediate job to the print server 250, the management server 220 may transmit an intermediate job to the print server 250 after the print server 250 updates job information, without transmitting the job request. However, the management server 220 executes various types of processing, such as storing the intermediate job and registering and updating the job information, and thus there is a possibility that the processing load is high. However, the efficiency of processing in the entire printing assisting system S is presumed to be high when the print server 250 transmits a job request at a timing at which the processing load is low. Thus, in the configuration employed in the first and second embodiments described above, the print server 250 transmits a job request, and the management server 220 that receives the job request transmits an intermediate job to the print server 250.

Although a configuration in which the second LB 22 and each web server 210 are separated from each other is employed in the first and second embodiments described above, each web server 210 may execute processing that is analogous to the processing executed by the second LB 22, and the second LB 22 may be omitted from the data center DC. Similarly, although a configuration in which the third LB 23 is separated from each management server 220 is employed, each management server 220 may execute processing that is analogous to the processing executed by the third LB 23, and the third LB 23 may be omitted from the data center DC. When an instruction for printing is issued once after a plurality of intermediate jobs is selected, there is a possibility that a print-instruction input date and time is duplicated. In such a case, a sequence numbers for identifying the printing order may be added to the ends of the print instruction input dates and times. When the multifunctional equipment 300 is capable of printing an image corresponding to a document file, based on an analysis result of an intermediate job, the print server 250 may transfer an intermediate job, transmitted and received from the management server 220, to the multifunctional equipment 300. In this case, the print server 250 does not have to generate a rendering job in accordance with an intermediate job transmitted and received from the management server 220. In this case, since the print server 250 does not generate a rendering job, the print server 250 does not transmit a rendering job.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing apparatus comprising:
a memory; and
a processor coupled to the memory and configured to execute a process that includes
receiving first information associated with an image forming apparatus,
issuing, to a server apparatus that manages first data, a first request after receiving the first information, the first request being a request for a first data set, the first data set including at least any one of the first data to be transferred to the image forming apparatus and the first data corresponding to second data to be transmitted to the image forming apparatus,
receiving the first data set requested by the first request, and
issuing, to the server apparatus, a second request after receiving the first data set, the second request being a request for a second data set, the second data set including at least any one of the first data to be transferred to the image forming apparatus and the first data corresponding to the second data to be transmitted to the image forming apparatus, and a content of the second data set being different from a content of the first data set.

2. The data processing apparatus according to claim 1,
wherein the second request is configured to request that the second data set includes, in a printing order, the at least any one of the first data to be transferred to the image forming apparatus and the first data corresponding to the second data to be transmitted to the image forming apparatus.

3. The data processing apparatus according to claim 1,
wherein the process is configured to be performed by a computer that includes at least one of a first computer having a function that is different from a function of the data processing apparatus, a second computer having a function that is same as a function of the data processing apparatus, or the server apparatus, when the computer detects a failure in the data processing apparatus.

4. The data processing apparatus according to claim 1,
wherein the first data is a print job that is not dependent on the image forming apparatus; and
wherein the second data is a print job that is dependent on the image forming apparatus.

5. A data processing apparatus comprising:
a memory; and
a processor coupled to the memory and configured to execute a process that includes
transmitting first information associated with the data processing apparatus,
obtaining the first data including second information associated with the first information from a server apparatus, the second information being associated with the image forming apparatus that receives a print instruction, the image forming apparatus being configured to manage the first data for a first print job and third information that associates the first data for the first print job with the second information, the first print job being a print job that is not dependent on the image forming apparatus.
generating second data for a second print job based on the obtained first data, the second print job being a print job that is dependent on the particular image forming apparatus, and
transmitting the generated second data to the image forming apparatus.

6. The data processing apparatus according to claim 5,
wherein the obtaining of the first data is configured to obtain the first data in order starting with an earliest date and time of the input of the print instruction.

7. The data processing apparatus according to claim 5,
wherein the process includes
receiving first information associated with a particular image forming apparatus that receives a print instruction,
transmitting the received first information to one of server apparatuses in accordance with amounts of load on the respective server apparatuses, each of the server apparatuses being a server configured to generate the second data based on the first data, and to transmit the second data to the particular image forming apparatus,
receiving the second information transmitted from the server apparatus to which the first information is transmitted,
managing the first information and the second information in association with each other, and
transmitting the first data including the first information associated with the second information to the server apparatus to which the first information is transmitted.

8. The data processing apparatus according to claim 7,
wherein the transmitting of the first data is configured to transmit the first data in order starting with an earliest date and time of the input of the print instruction.

9. A non-transitory computer-readable storage medium for storing a program which causes a processor to perform processing, the processing comprising:
receiving first information associated with an image forming apparatus,
issuing, to a server apparatus that manages first data, a first request after receiving the first information, the first request being a request for a first data set, the first data set including at least any one of the first data to be transferred to the image forming apparatus and the first data corresponding to second data to be transmitted to the image forming apparatus,
receiving the first data set requested by the first request, and
issuing, to the server apparatus, a second request after receiving the first data set, the second request being a request for a second data set, the second data set including at least any one of the first data to be transferred to the image forming apparatus and the first data corresponding to the second data to be transmitted to the image forming apparatus, and a content of the second data set being different from a content of the first data set.
